(19) United States
(12) Patent Application Publication
(10) Pub. No.: US 2017/0313157 A1
(43) Pub. Date: Nov. 2, 2017

(54) METHOD FOR CHANGING COOLANT IN A VEHICLE ENGINE

(71) Applicant: Thong DAO, Sacramento, CA (US)

(72) Inventor: Thong DAO, Sacramento, CA (US)

(21) Appl. No.: 15/499,792

(22) Filed: Apr. 27, 2017

Related U.S. Application Data
(60) Provisional application No. 62/328,438, filed on Apr. 27, 2016.

(51) Int. Cl. B60H 1/00

(52) U.S. Cl. CPC B60H 1/00585

(57) ABSTRACT

The present invention provides a system and method for efficiently replacing the coolant in a vehicle engine and for checking the integrity of the coolant system to identify leaks.

### CROSS REFERENCE TO RELATED APPLICATIONS

This application claims priority to U.S. Provisional Application No. 62/328,438 filed Apr. 27, 2016, the contents of which are incorporated herein by reference in their entirety.

### FIELD OF INVENTION

The present invention relates to the field of servicing engines and provides a system and an efficient method for the replacement of coolant in a vehicle engine.

### BACKGROUND OF INVENTION

The cooling system is essential for proper operation of vehicles of many types. Vehicles rely heavily on the cooling system for optimum operation and the protection of the vehicle from overheating.

There is a need for a coolant removal and replacement system and method that provides efficient extraction of old coolant and the insertion of new coolant in a vehicle engine system while avoiding spilling of the coolant. There has existed a need for a system or method which can accommodate the function of extracting old coolant and the insertion of new coolant while also providing a means for testing the integrity of the coolant system.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The embodiments disclosed herein provide a solution to the problem experienced when vacuum filling a cooling system of a vehicle with coolant, wherein other methods do not efficiently evacuate all of the old coolant before introducing the new coolant. The embodiments also address the problem of allowing for the testing of the integrity of the coolant system to check for leaks after the old coolant has been removed.

In the disclosed embodiments, a vacuum (i.e., negative pressure) is initially applied at one end of the coolant system (e.g., through the coolant reservoir through a fill tool) to prevent leaking of coolant when an opening is created to evacuate the coolant. Evacuation of the coolant through the vehicular coolant system then occurs through the opening when positive pressure is applied through the coolant reservoir with a fill tool. In another aspect, the coolant system is sealed off and connected to a vacuum after the old coolant has been removed to determine how well the vacuum is maintained in the closed coolant system. If the negative pressure created by the vacuum cannot be maintained in the closed coolant system then a leak is present and may be repaired prior to addition of the new coolant.

### BRIEF DESCRIPTION OF THE DRAWINGS

FIG. 1 illustrates a representative embodiment of a fill tool with pressure gauges and an adaptor to connect to a vehicular coolant reservoir and apply negative or positive pressure in accordance with the embodiments provided herein.

FIG. 2 illustrates a closer view of the representative embodiment of the fill tool.

FIG. 3 illustrates a representative embodiment in which an optional muffler has been added to reduce the noise generated by the fill tool.

FIG. 4 illustrates another view of the representative embodiment with the optional muffler.

FIG. 5 illustrates a representative embodiment of the fill tool connected to a source of pressure (i.e., shop air) used for applying negative or positive pressure through the fill tool.

FIG. 6 illustrates another view of the fill tool connected to the source of pressure (i.e., shop air).

FIG. 7A illustrates an alternative embodiment of the fill tool connected to a coolant reservoir inlet and a source of pressure during the initial application of negative pressure to the vehicular cooling system. FIG. 7B illustrates the alternative embodiment of the fill tool connected to a coolant reservoir inlet and a sources of pressure during the removal of coolant from the vehicular cooling system.

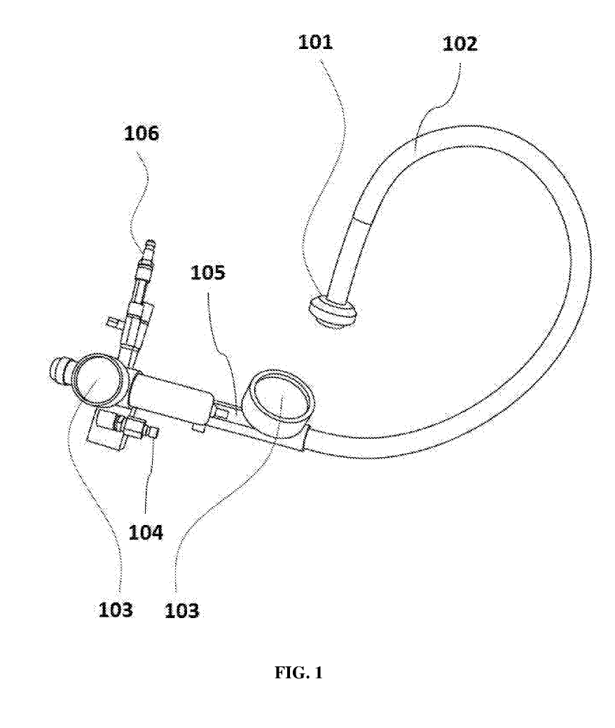

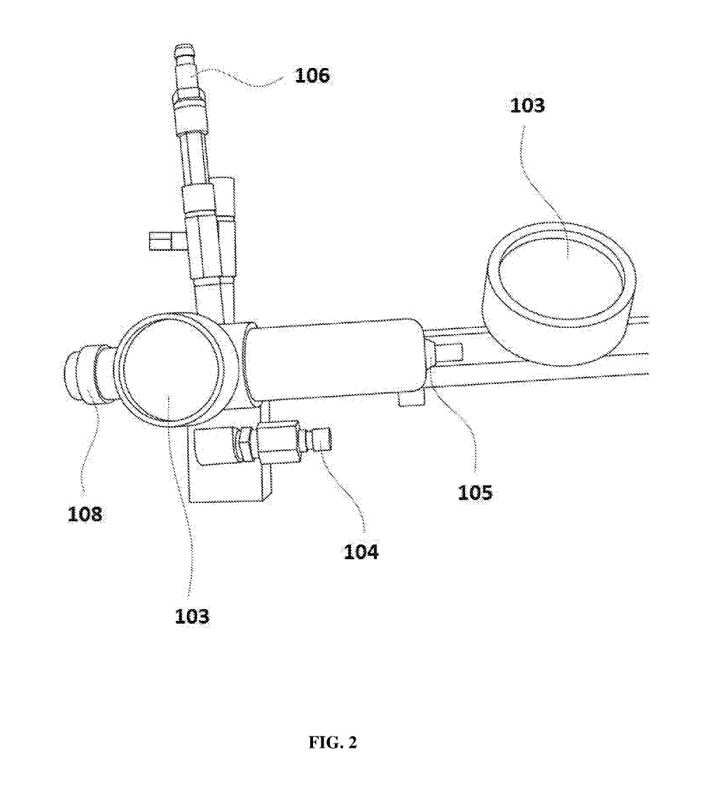

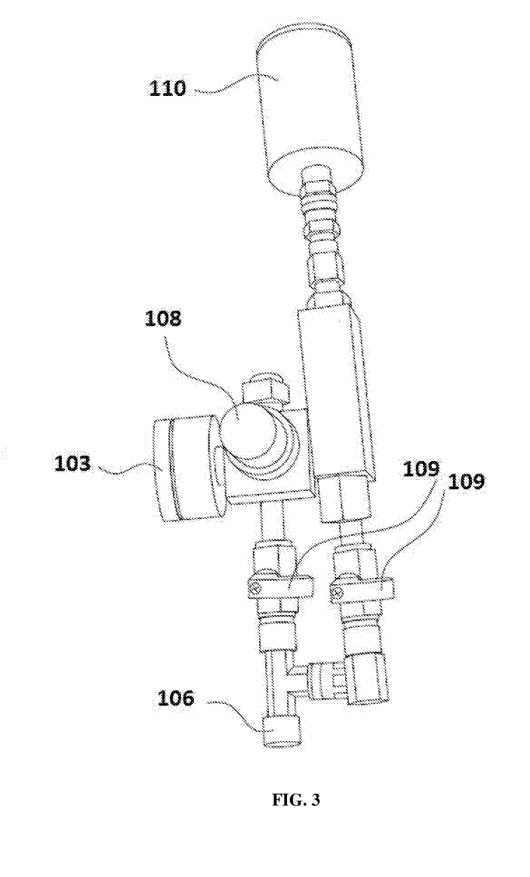

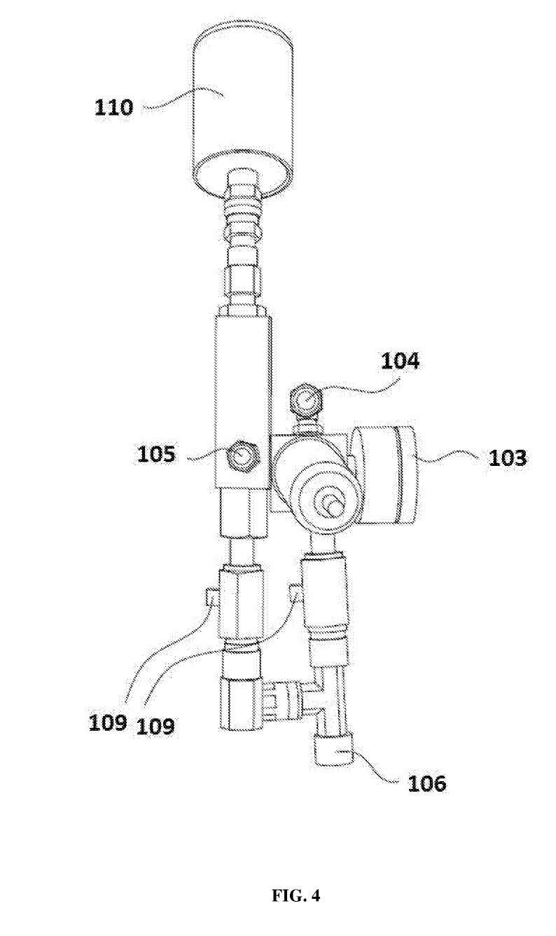

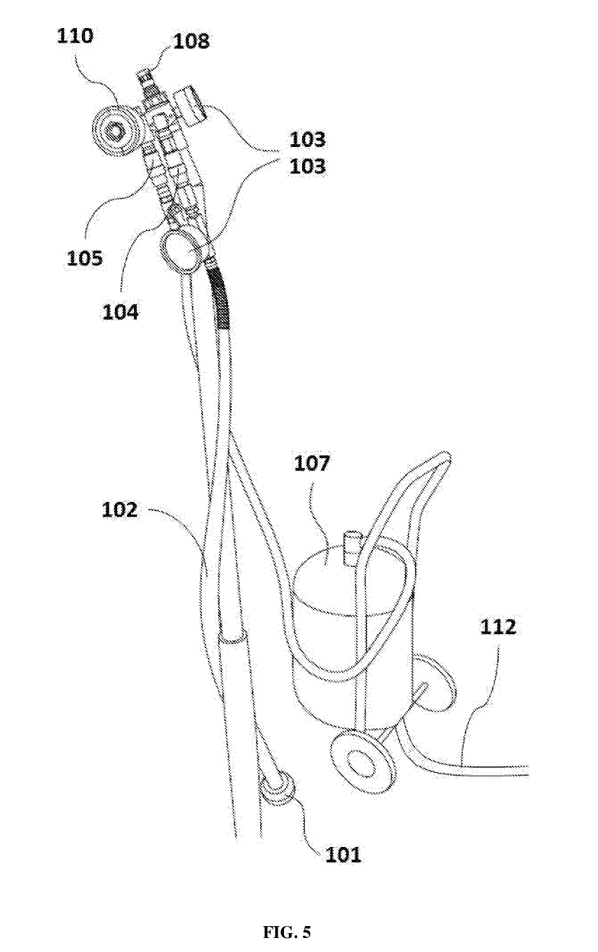

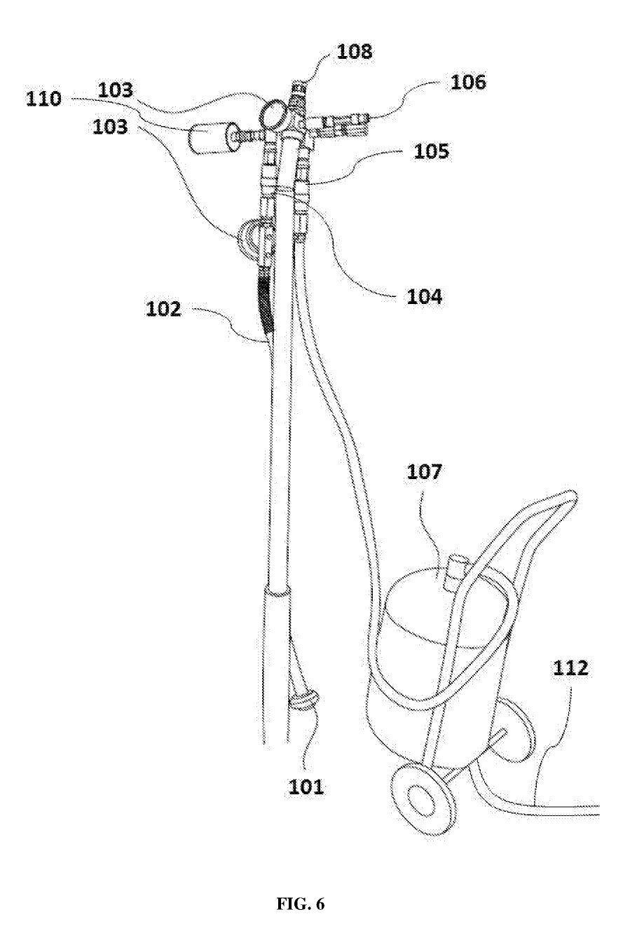

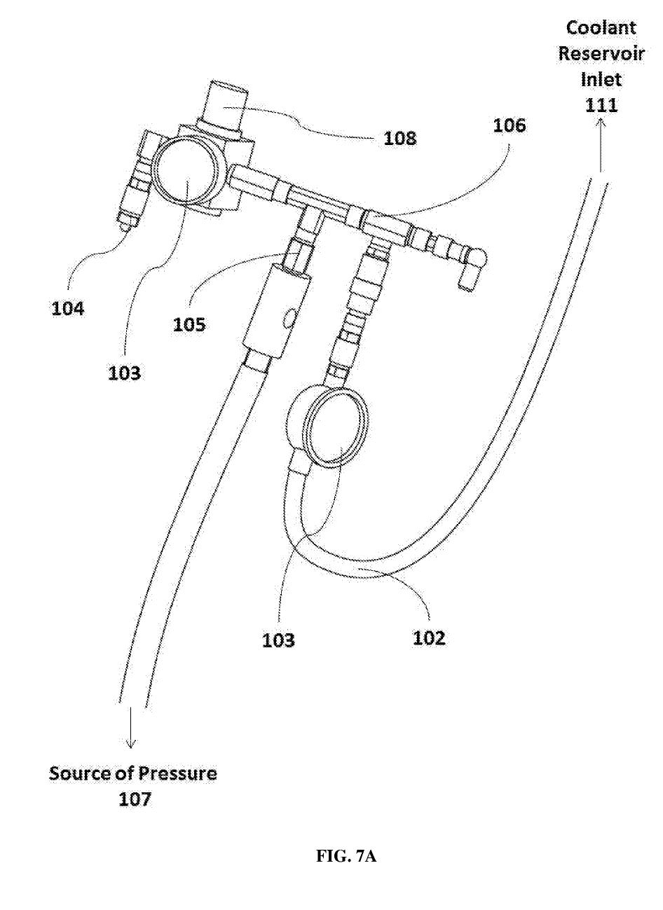

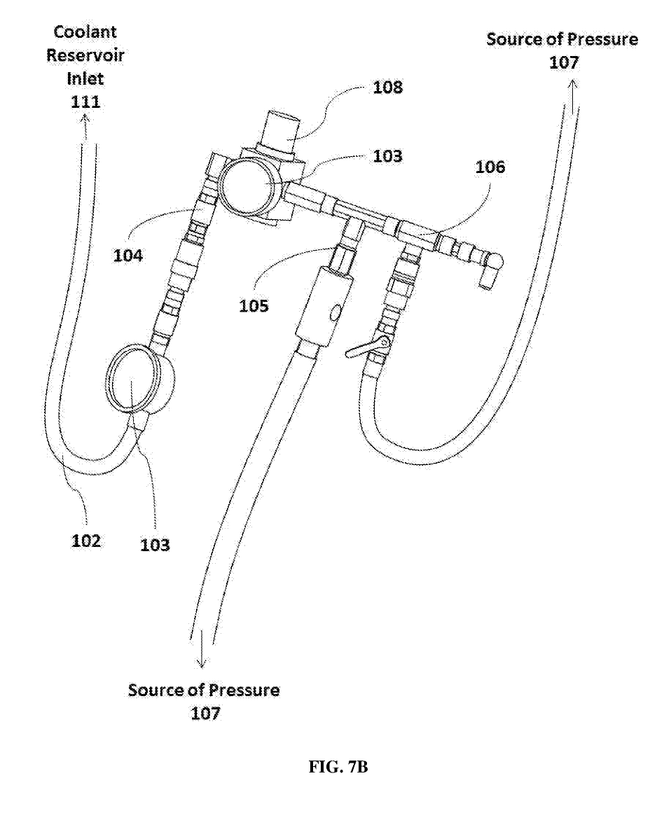

### DETAILED DESCRIPTION

In one embodiment, the disclosure provides a method for vacuum filling a vehicular cooling system with coolant, comprising: providing a vehicular cooling system comprising a coolant reservoir having a coolant reservoir inlet 111 and a coolant reservoir outlet, the coolant reservoir outlet being in liquid communication with the coolant reservoir inlet 111; providing a source of coolant; providing a fill tool, comprising a tube 102 with an adaptor 101 that connects to the coolant reservoir at the coolant reservoir inlet 111, an outlet 105 for applying negative pressure, a first inlet 104 for applying positive pressure, a second inlet 106 for applying positive pressure, a knob 108 to adjust pressure applied to the coolant reservoir, at least one valve 109 to control air flow, at least one pressure gauge 103 to monitor the pressure applied through the fill tool, and, optionally, a muffler 110 to reduce noise from the fill tool; and; providing a source of pressure 107 capable of applying positive or negative pressure through the fill tool; attaching the fill tool to the vehicular cooling system by connecting the adaptor 101 to the coolant reservoir inlet 111 to form an airtight seal; applying negative pressure to the cooling system inlet with the source of pressure 107 through the fill tool; disconnecting a tube of the vehicular cooling system to create an opening in the vehicular coolant system; applying positive pressure to the coolant reservoir inlet 111 with the source of pressure 107 through the fill tool to evacuate coolant through the opening in the vehicular coolant system; connecting the source of coolant to the opening in the vehicular coolant system once the coolant is evacuated; and applying negative pressure to the cooling system inlet with the source of pressure 107 through the fill tool to draw coolant into the vehicular coolant system from the source of coolant.

The “coolant reservoir” as used herein refers to both the reservoir where excess coolant is kept and the radiator of the vehicle.

In another embodiment, the method further comprises after evacuating the coolant when the vehicular cooling system has little or no coolant reconnecting the tube of the vehicular cooling system to close the opening in the vehicular coolant system; applying negative pressure to the cooling system inlet with the source of pressure 107 through the fill tool; and confirming that a vacuum is maintained throughout the vehicular cooling system after application of the negative pressure to evaluate the integrity of the cooling system.

In certain aspects, greater than 50%, greater than 60%, greater than 70%, greater than 80%, greater than 85%, greater than 90%, greater than 95%, or greater than 98% of the coolant is evacuated from the vehicular cooling system.

In other aspects, less than 20 psi, less than 19 psi, less than 18 psi, less than 17 psi, less than 16 psi, less than 15 psi, less than 14 psi, less than 13 psi, less than 12 psi, less than 11 psi, or less than 10 psi of pressure is applied to the vehicular cooling system through the fill tool at any point of the process.

In one embodiment, the coolant is collected in the source of pressure 107. The source of pressure 107 may be shop air. In one aspect, the shop air comprises a pressurized, air tight container that can be used to generate positive pressure for filling the vehicular cooling system with coolant or negative pressure for evacuation of coolant from the vehicular cooling system through the fill tool. In certain aspects, a vacuum is created in the pressurized air tight container to collect coolant evacuated from the vehicular cooling system. This evacuated coolant may then be disposed of or reintroduced into the vehicular cooling system from the hose 112 extending from the bottom of the pressurized air tight container.

In yet another embodiment, the disclosure is directed to a vehicle engine coolant changing system comprising: an old coolant container having an inlet opening and an outlet opening, a new coolant container having an inlet opening and an outlet opening, an adaptor 101 for a coolant reservoir and having a passage there through, the adaptor 101 has a tapered configuration to engage in service openings of various sizes, an old solution conduit interconnecting an engine interior and said inlet opening of the old coolant container for transfer of old coolant from the engine interior to the old coolant container, a new conduit interconnecting the new coolant container and the adapter to pass new coolant from the new coolant container into the engine, means to provide a partial vacuum in the old coolant container to draw old coolant from the engine interior into the old coolant container via a conduit, means to apply positive pressure to efficiently evacuate the old coolant while the vacuum is applied and to urge new coolant from the new coolant container into the engine, a first control operable to provide rapid and efficient changes in vacuum flow patterns via conduits and valves of the system, and a second control operable to provide rapid and efficient changes in positive pressure flow patterns via conduits and valves of the system.

It is understood that the disclosed invention is not limited to the particular methodology, protocols and materials described as these can vary. It is also understood that the terminology used herein is for the purposes of describing particular embodiments only and is not intended to limit the scope of the present invention which will be limited only by the appended claims.

Those skilled in the art will recognize, or be able to ascertain using no more than routine experimentation, many equivalents to the specific embodiments of the invention described herein. Such equivalents are intended to be encompassed by the following claims.

We claim:

1. A method for vacuum filling a vehicular cooling system with coolant, comprising:
providing a vehicular cooling system comprising a coolant reservoir having a coolant reservoir inlet and a coolant reservoir outlet, the coolant reservoir outlet being in liquid communication with the coolant reservoir inlet;
providing a source of coolant;
providing a fill tool, comprising a tube with an adaptor that connects to the coolant reservoir at the coolant reservoir inlet, an outlet for applying negative pressure, a first inlet for applying positive pressure, a second inlet for applying positive pressure, a knob to adjust pressure applied to the coolant reservoir, at least one valve to control air flow, at least one pressure gauge to monitor the pressure applied through the fill tool, and, optionally, a muffler to reduce noise from the fill tool;
providing a source of pressure capable of applying positive or negative pressure through the fill tool;
attaching the fill tool to the vehicular cooling system by connecting the adaptor to the coolant reservoir inlet to form an airtight seal;
applying negative pressure to the cooling system inlet with the source of pressure through the fill tool;
disconnecting a tube of the vehicular cooling system to create an opening in the vehicular coolant system;
applying positive pressure to the coolant reservoir inlet with the source of pressure through the fill tool to evacuate coolant through the opening in the vehicular coolant system;
connecting the source of coolant to the opening in the vehicular coolant system once the coolant is evacuated; and
applying negative pressure to the cooling system inlet with the source of pressure through the fill tool to draw coolant into the vehicular coolant system from the source of coolant.

2. The method of claim 1, further comprising:
after evacuating the coolant when the vehicular cooling system has little or no coolant reconnecting the tube of the vehicular cooling system to close the opening in the vehicular coolant system;
applying negative pressure to the cooling system inlet with the source of pressure through the fill tool; and
confirming that a vacuum is maintained throughout the vehicular cooling system after application of the negative pressure to evaluate the integrity of the cooling system.

3. The method of claim 1, wherein greater than 90% of the coolant is evacuated from the vehicular cooling system.

4. The method of claim 1, wherein the source of pressure is shop air.

5. A vehicle engine coolant changing system comprising:
an old coolant container having an inlet opening and an outlet opening,
a new coolant container having an inlet opening and an outlet opening,
an adaptor for a coolant reservoir and having a passage there through, the adaptor has a tapered configuration to engage in service openings of various sizes,
an old solution conduit interconnecting an engine interior and said inlet opening of the old coolant container for transfer of old coolant from the engine interior to the old coolant container,
a new conduit interconnecting the new coolant container and the adapter to pass new coolant from the new coolant container into the engine,
means to provide a partial vacuum in the old coolant container to draw old coolant from the engine interior into the old coolant container via a conduit,
means to apply positive pressure to efficiently evacuate the old coolant while the vacuum is applied and to urge new coolant from the new coolant container into the engine,
a first control operable to provide rapid and efficient changes in vacuum flow patterns via conduits and valves of the system, and
a second control operable to provide rapid and efficient changes in positive pressure flow patterns via conduits and valves of the system.
